(19) United States
(12) Patent Application Publication
(10) Pub. No.: US 2026/0009494 A1
(43) Pub. Date: Jan. 8, 2026

(54) CLAMPING DEVICE FOR NEAR-FIELD INDUCTION AUTOMATED ELECTRONIC EQUIPMENT

(71) Applicant: Fuzhou EMONITA Technology Co., Ltd., Fuzhou (CN)

(72) Inventor: Tengqin Zhou, Fuzhou (CN)

(21) Appl. No.: 19/328,532

(22) Filed: Sep. 15, 2025

(51) Int. Cl. F16M 11/04

(52) U.S. Cl. CPC F16M 11/04; F16M 2200/027

(57) ABSTRACT

A clamping device for near-field induction automated electronic equipment comprises a base and an electric chuck component, which are movably connected. A clamping mechanism is installed inside the electric chuck component and comprises a power module, a drive motor, a lead screw, a movable clamping plate, a motor bracket and a threaded sliding block. The lead screw is installed at the output end of the drive motor. The threaded sliding block is arranged in the electric chuck component, is driven by the lead screw, and is connected to the back of the movable clamping plate. The drive motor drives the threaded sliding block to move the movable clamping plate up and down. The movable clamping plate clamps and secures the equipment onto the electric chuck component. Additionally, a proximity sensor is installed on the electric chuck component.

### TECHNICAL FIELD

The invention relates to the technical field of electronic equipment clamping structures, in particular to a clamping device for near-field induction automated electronic equipment.

### BACKGROUND ART

Electronic equipment clamping technology refers to an engineering solution that utilizes mechanical structures or electromechanical devices to securely fix, precisely position, and controllably move various finished electronic devices (such as smartphones, tablets, laptops, etc.). An electronic equipment clamping system typically comprises four components: a clamping mechanism, a drive device, a sensing system and a control system. It is widely utilized in practical applications of electronic equipment.

The existing electronic equipment clamping still exhibits the following problems in actual use:

Currently, most electronic equipment clamping devices adopt mechanical buckles or manual locking structures, which result in cumbersome operation, high complexity and poor adaptability. Traditional sensing solutions (e.g., infrared sensors) are susceptible to environmental interference and lack precision in detecting nearby metal objects, thereby making the automatic clamping triggering difficult. Moreover, existing clamping mechanisms often rely on a single drive mode and lack intelligent control functions, failing to balance the needs of secure clamping and convenient release.

### SUMMARY OF THE INVENTION

The invention provides a clamping device for near-field induction automated electronic equipment. By technically modifying the existing clamping device, the invention solves the problems in the existing clamping equipment, such as lack of automatic clamping and intelligent control functions, poor adaptability to large electronic equipment, and inconsistent clamping force.

To achieve the above-mentioned purpose, the invention adopts the following technical proposal:

A clamping device for near-field induction automated electronic equipment comprises a base and an electric chuck component; the base and the electric chuck component are movably connected. A clamping mechanism is installed inside the electric chuck component and comprises a power module, a drive motor, a lead screw, a movable clamping plate, a motor bracket and a threaded sliding block. The power module is fixedly installed inside the electric chuck component; the motor bracket is fixedly arranged inside the electric chuck component, and the drive motor is also fixedly installed in the motor bracket. The lead screw is installed at the output end of the drive motor. The threaded sliding block, arranged in the electric chuck component, is connected to the lead screw in a driveway, and is connected to the back of the movable clamping plate. The movable clamping plate is slidably connected to the electric chuck component. The drive motor drives the threaded sliding block to move the movable clamping plate up and down relative to the electric chuck component. A force accumulation device is also arranged between the movable clamping plate and the threaded sliding block. The movable clamping plate is used to clamp and secure the equipment onto the electric chuck component.

A proximity sensor for detecting the equipment to be clamped is also installed on the electric chuck component. A main control board is arranged inside the electric chuck component, and the power module, the drive motor, the proximity sensor and the main control board are electrically connected.

Preferably, the proximity sensor comprises an eddy current proximity sensor, a capacitive near-field sensor or an infrared proximity sensor.

Preferably, a clamping bracket is fixedly arranged at the bottom of the electric chuck component, and the equipment to be clamped is clamped and fixed between the movable clamping plate and the clamping bracket.

Preferably, a button is arranged at the bottom center on the back of the electric chuck component, and the electric chuck component is also provided with an indicator light strip. Both the button and the indicator light strip are electrically connected to the main control board.

Preferably, a damping rotating shaft hinged seat is fixedly installed on the upper surface of the base. A connecting plate is movably installed on the damping rotating shaft hinged seat. The other end of the connecting plate deviating from the base is connected to the electric chuck component through a buckle component.

Preferably, steel shafts are fixedly installed on both sides inside the electric chuck component. An upper fixing plate and a lower fixing plate extend horizontally from the back of the movable clamping plate. The steel shafts pass through both the upper fixing plate and the lower fixing plate, allowing the movable clamping plate to slide up and down along the steel shafts. The threaded sliding block and the force accumulation device are installed between the upper and lower fixing plates.

The force accumulation device comprises a force accumulation spring and a movable sleeve. The threaded sliding block and the movable sleeve are sleeved on the steel shafts. The compressed force accumulation spring is installed between the threaded sliding block and the movable sleeve. The upper end of the threaded sliding block is abutted against the upper fixing plate, while the lower end of the movable sleeve is abutted against the lower fixing plate.

Preferably, the electric chuck component comprises a front housing and a rear housing. The motor bracket is fixedly installed on the rear housing. The movable clamping plate comprises an upper movable clamping plate and a lower movable clamping plate. The drive motor adopts a dual-output structure. The lead screws connected to the upper and lower output ends of the drive motor are respectively driven and connected to the threaded sliding blocks installed in the upper and lower movable clamping plates. A force accumulation device is also arranged between the threaded sliding blocks and the movable clamping plates.

Preferably, the force accumulation device comprises a force accumulation spring and steel mounting shafts. The movable clamping plate is provided with a sliding block mounting groove. The lead screw passes through the sliding block mounting groove and is threadedly connected to the threaded sliding block installed in the sliding block mounting groove. Steel mounting shafts are fixedly installed on both sides of the lead screw within the sliding block mounting groove. The threaded sliding block is sleeved on the steel mounting shaft and moves up and down along the steel mounting shaft. The force accumulation spring is also installed on the steel mounting shaft and is abutted against both the sliding block mounting groove and the threaded sliding block.

Preferably, a steel limit shaft is fixedly installed in the rear housing, and the upper and lower movable clamping plates are sleeved on the steel limit shaft, allowing them to move up and down along the steel limit shaft.

The invention has the following advantages:

The invention is provided with a power module, drive motor, lead screws, threaded sliding blocks and a proximity sensor. The movable clamping plate is slidably installed on the electric chuck component. The power module supplies power to the drive motor; the drive motor drives the threaded sliding block via the lead screws. The threaded sliding blocks drive the movable clamping plates to move up and down relative to the electric chuck component, thereby clamping electronic equipment of different specifications.

The proximity sensor arranged in the invention can detect whether the electronic equipment is placed on the electric chuck component. Upon detecting the electronic equipment, the main control board controls the drive motor to perform automated clamping operations. The button and the indicator light strip enable intuitive operation, enhancing practical convenience during use. This design improves clamping efficiency, achieves one-handed operation, and facilitates quick and easy fixing and removal of tablets.

The invention is also equipped with a force accumulation device such as a connecting spring or force accumulation spring. The spring can accumulate force to continuously maintain a high pressure on electronic equipment such as tablets, even when tightened to different sizes. Moreover, the pressure is relatively balanced ensuring that the clamping effect is consistent regardless of the tablet size, thereby making clamping more efficient and stable.

### BRIEF DESCRIPTION OF THE DRAWINGS

FIG. 1 is a schematic diagram of the overall structure in Embodiment 1 of the invention.

FIG. 2 is a schematic diagram of the rear structure in Embodiment 1 of the invention.

FIG. 3 is a schematic diagram of the internal structure in Embodiment 1 of the invention.

FIG. 4 is a structural diagram of the force accumulation device in Embodiment 1 of the invention.

FIG. 5 is a schematic diagram of the overall structure in Embodiment 2 of the invention.

FIG. 6 is a schematic diagram of the rear structure in Embodiment 2 of the invention.

FIGS. 7 and 8 are schematic diagrams for the internal structure of the clamping mechanism in Embodiment 2 of the invention.

FIG. 9 is a structural diagram of the force accumulation device in Embodiment 2 of the invention.

Description of reference signs: 1. Base; 2. Damping rotating shaft hinged seat; 3. Connecting plate; 4. Buckle component; 5. Electric chuck component; 51. Front housing; 52. Back housing; 6. Power module; 7. Drive motor; 8. Lead screw; 9. Movable clamping plate; 91. Upper movable clamping plate; 92. Lower movable clamping plate; 93. Upper fixing plate; 94. Lower fixing plate; 10. Clamping bracket; 11. Motor bracket; 12. Proximity sensor; 13. Button; 14. Indicator light strip; 15. Threaded sliding block; 16. Steel shaft; 17. Movable sleeve; 18. Steel limit shaft; 19. Main control board; 20. Force accumulation spring; 21. Steel mounting shaft.

### DETAILED DESCRIPTION OF THE INVENTION

The invention will be elaborated in detail below in conjunction with the drawings and embodiments.

### Embodiment 1

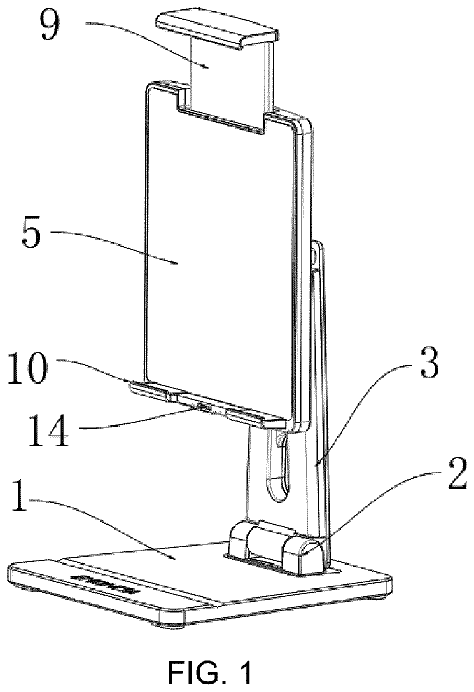

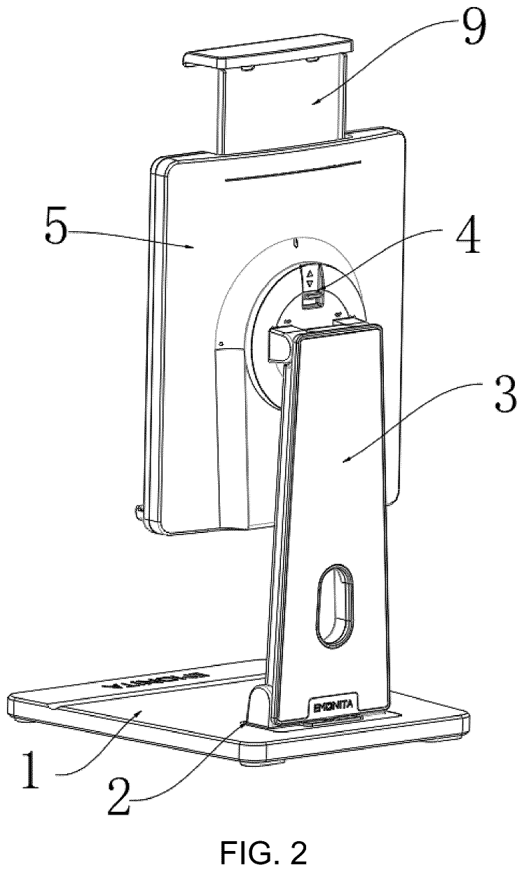

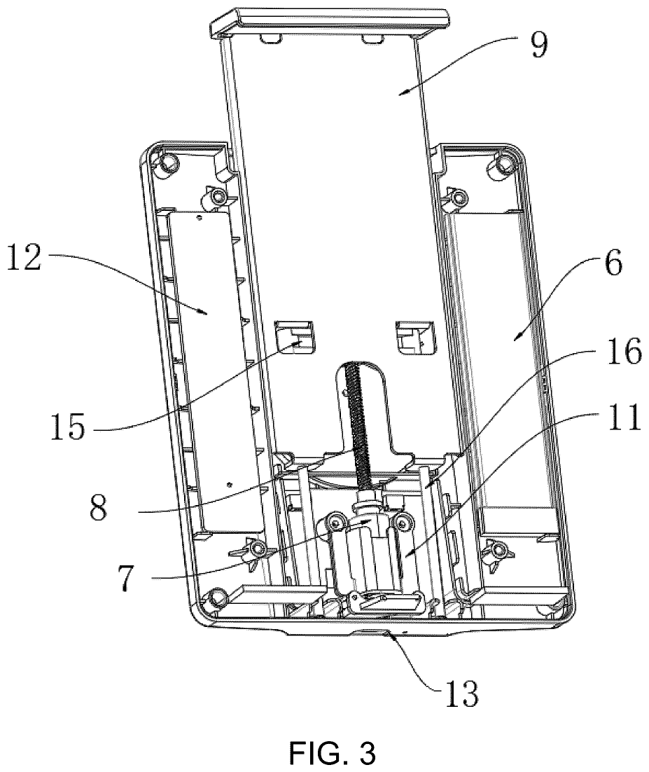

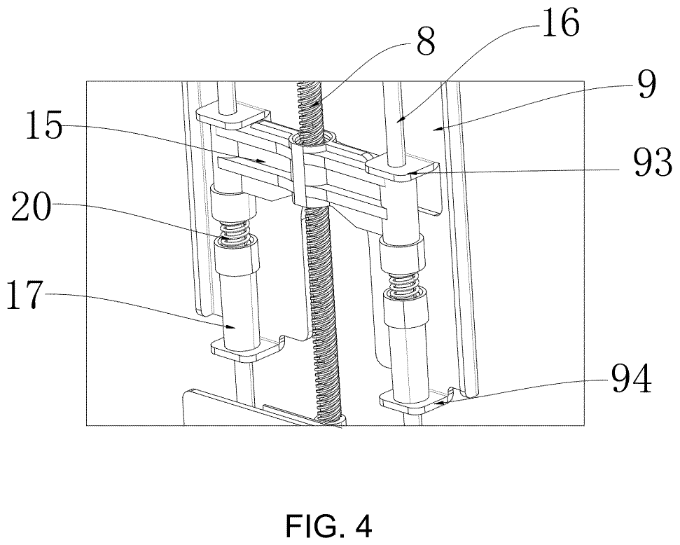

As shown in FIG. 1 to FIG. 4, the invention provides a clamping device for near-field induction automated electronic equipment. The device comprises a base 1 and an electric chuck component 5, which are movably connected. A clamping mechanism is installed inside the electric chuck component and comprises a power module 1, a drive motor 7, a lead screw 8, a movable clamping plate 9, a motor bracket 11, and a threaded sliding block 15. The power module 6 is fixedly installed inside the electric chuck component 5. The motor bracket 11 is fixedly arranged inside the electric chuck component 5. The drive motor 7 is fixedly installed in the motor bracket 11. The lead screw 8 is installed at the output end of the drive motor 7. The threaded sliding block 15 is arranged in the electric chuck component 5, is connected to the lead screw 8 for driving, and is connected to the back of the movable clamping plate 9. The movable clamping plate 9 is slidably connected to the electric chuck component 5. The drive motor 7 drives the threaded sliding block 15 to move the movable clamping plate 9 up and down relative to the electric chuck component 5. A force accumulation device is also arranged between the movable clamping plate 9 and the threaded sliding block 15. The movable clamping plate 9 is used to clamp and fix the equipment to be clamped on the electric chuck component 5.

A proximity sensor 12 for detecting the equipment to be clamped is also installed on the electric chuck component 5. A main control board 19 is arranged inside the electric chuck component 5, and the power module 6, the drive motor 7, the proximity sensor 12 and the main control board 19 are electrically connected.

A rechargeable lithium battery can be used as the power module 6.

Furthermore, an eddy current proximity sensor 12 is selected as the proximity sensor 12. A clamping bracket 10 is fixedly arranged at the bottom of the electric chuck component 5, and the equipment to be clamped is clamped and fixed between the movable clamping plate 9 and the clamping bracket 10.

A button 13 is arranged in the bottom center of the back of the electric chuck component 5; the electric chuck component 5 is also provided with an indicator light strip 14. Both the button 13 and the indicator light strip 14 are electrically connected to the main control board 19.

During use, the electronic equipment is placed on the upper surface of the clamping bracket 10. The eddy current proximity sensor 12 built into the electric chuck component 5 then detects the metal casing or internal metal parts of the electronic equipment in real time within a range of 1 to 5 mm. When the eddy current proximity sensor 12 detects the approaching electronic equipment, it sends a signal to the main control board 19. The lithium battery powers the drive motor 7 to trigger the drive motor 7 to rotate the lead screw 8. This rotation drives the threaded sliding block 15 on the outer surface of the lead screw 8 to move downward, which in turn drives the movable clamping plate 9 to move downward. Thus, the electronic equipment placed can be automatically fixed through the movable clamping plate 9. In order to loosen the electronic equipment, the user presses the button 13 integrated on the main control board 19. This action triggers the indicator light strip 14 to alert the user and drives the motor 7 to rotate in the reverse direction, moving the movable clamping plate 9 upwards. The movable clamping plate 9 leaves the top of the electronic equipment, and then the electronic equipment can be removed.

The eddy current proximity sensor 12 is fixedly installed inside the electric chuck component 5. When the electronic equipment approaches the electric chuck component 5 within a certain sensing distance, the sensor automatically detects the presence of the equipment. This feature enables the clamping device to start without manual operation, achieving automated sensing triggering and significantly improving the operation's convenience and efficiency. During clamping and operation of electronic equipment, the clamping bracket 10 effectively prevents the electric chuck component 5 from shaking or tilting, ensuring smooth operation. The button 13 located at the bottom center of the electric chuck component 5 provides users with a convenient operation mode. Users can easily start or stop the clamping device or make other related settings through button 13. The indicator light strip 14 located at the bottom center of the front of the electric chuck component 5 provides real-time feedback on the device's operating status.

Moreover, a damping rotating shaft hinged seat 2 is fixedly installed on the upper surface of the base 1. A connecting plate 3 is movably installed on the damping rotating shaft hinged seat 2; the other end of the connecting plate 3 deviating from the base 1 is connected to the electric chuck component 5 through a buckle component 4. This arrangement allows the electric chuck component 5 to be conveniently installed and disassembled through the buckle component 4, and can be quickly and conveniently rotated through the damping rotating shaft hinged seat 2 and the connecting plate 3 to adjust the support angle, making it more convenient to use.

Furthermore, steel shafts 16 are fixedly installed on both sides inside the electric chuck component 5. An upper fixing plate 93 and a lower fixing plate 94 extend horizontally on the back of the movable clamping plate 9. The steel shafts 16 pass through the upper fixing plate 93 and the lower fixing plate 94, allowing the movable clamping plate 9 to slide up and down along the steel shafts 16. The threaded sliding block 15 and the force accumulation device are installed between the upper fixing plate 93 and the lower fixing plate 94.

The force accumulation device comprises a force accumulation spring 20 and a movable sleeve 17. Both the threaded sliding block 15 and the movable sleeve 17 are sleeved on the steel shafts 16. The compressed force accumulation spring 20 is installed between the threaded sliding block 15 and the movable sleeve 17. The upper end of the threaded sliding block 15 is abutted against the upper fixing plate 93, and the lower end of the movable sleeve 17 is abutted against the lower fixing plate 94.

In Embodiment 1, the force accumulation device is arranged to ensure that the equipment of different specifications is under uniform clamping force, maintaining a constant clamping pressure, avoiding excessive hard clamping and keeping stronger clamping stability. As a force accumulation element, the spring absorbs and offsets part of the vibration from the base 1, buffering vibration and impact, and improving overall performance.

### Embodiment 2

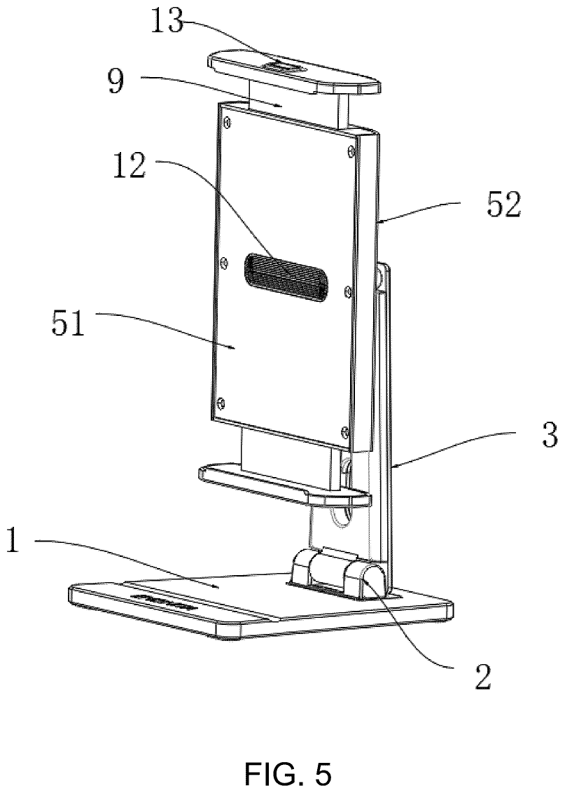

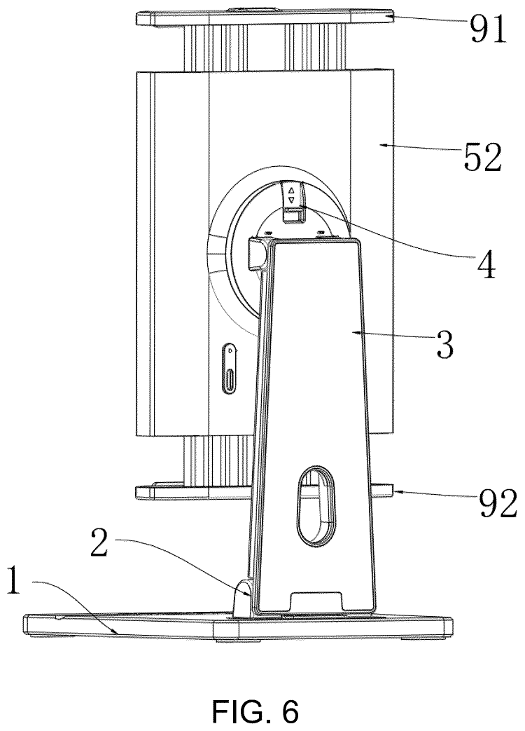

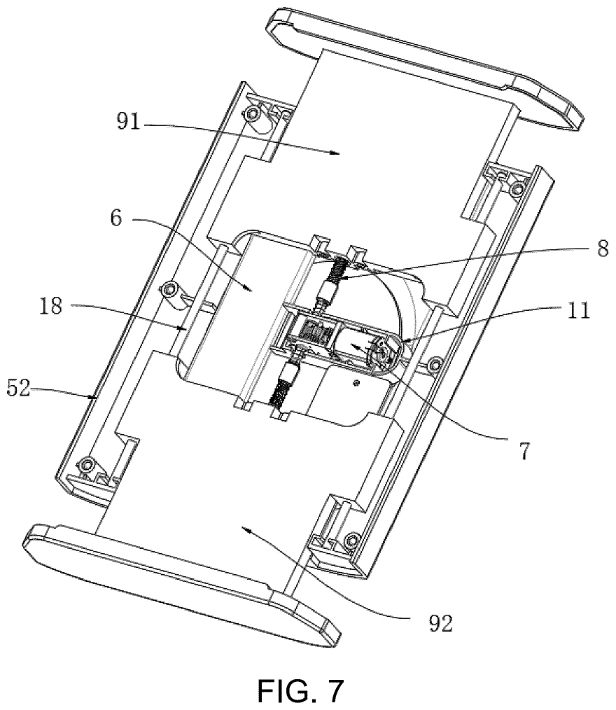

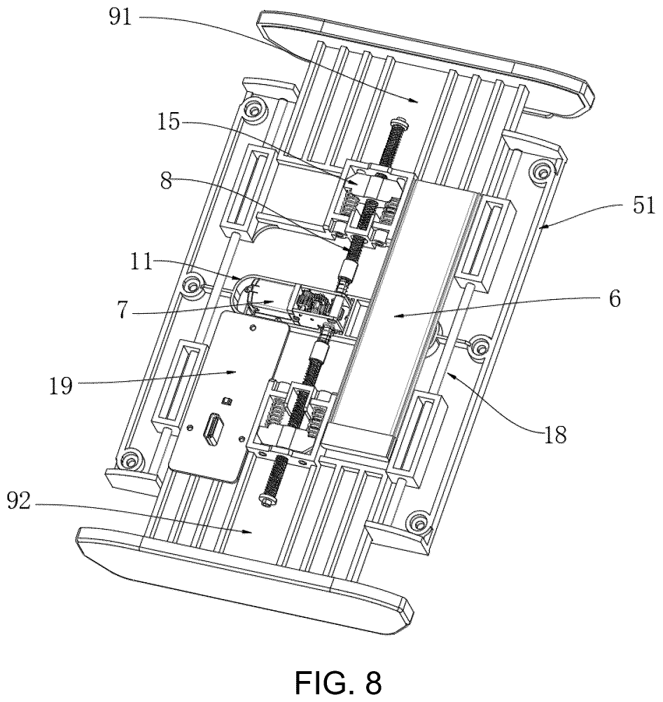

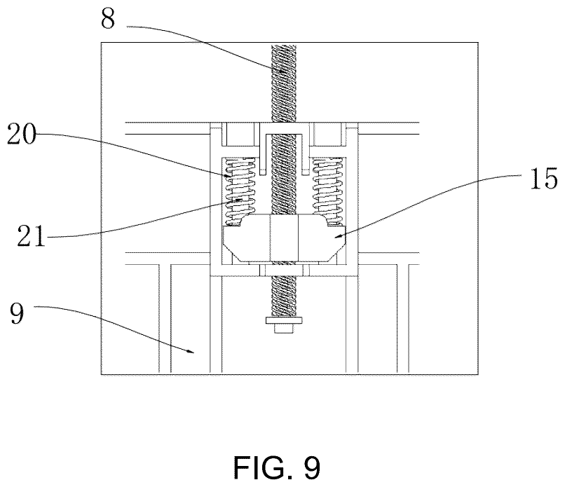

As shown in FIG. 5 to FIG. 9, the electric chuck component 5 comprises a front housing 51 and a rear housing 52, with the motor bracket 11 fixedly installed on the rear housing 52. The movable clamping plate 9 comprises an upper movable clamping plate 91 and a lower movable clamping plate 92. The drive motor 7 adopts a dual-output structure. The lead screws 8 connected to the upper and lower output ends of the drive motor 7 are respectively driven and connected to the threaded sliding blocks 15 installed in the upper movable clamping plate 91 and the lower movable clamping plate 92. A force accumulation device is also arranged between the threaded sliding blocks 15 and the movable clamping plates 9.

A proximity sensor 12 is installed in the middle of the front housing 51. A capacitive proximity sensor is used as the proximity sensor 12 to minimize the interference from foreign objects to the greatest extent.

Furthermore, to achieve the force accumulation effect of the force accumulation device, the force accumulation device comprises a force accumulation spring 20 and steel mounting shafts 21. The movable clamping plate 9 is provided with a sliding block mounting groove. The lead screw 8 passes through the sliding block mounting groove to be in threaded connection with the threaded sliding block 15 installed in the sliding block mounting groove. The steel mounting shafts 21 are fixedly installed on both sides of the lead screw in the sliding block mounting groove. The threaded sliding block 15 is sleeved on the steel mounting shaft 21 and moves up and down along the steel mounting shaft 21. The force accumulation spring 20 is also installed on the steel mounting shaft 21 and is abutted against the sliding block mounting groove and the threaded sliding block 15.

Moreover, to ensure that the movable clamping plate 9 is slidably installed on the electric chuck component 5, a steel limit shaft 18 is fixedly installed in the rear housing 52. The upper movable clamping plate 91 and the lower movable clamping plate 92 are sleeved on the steel limit shaft 18, allowing them to move up and down along the steel limit shaft 18.

A button 13 is installed at the upper end of the movable clamping plate 91.

During use, the upper movable clamping plate 91 and lower movable clamping plate 92 are first extended to their maximum positions through the button 13, and the tablet and other electronic equipment are placed between them. After detecting the tablet, the capacitive near-field sensor immediately feeds the information back to the main control board 19 through the wire. The main control board 19 then controls the drive motor 7 to operate and drive the lead screws 8 on both sides of the motor to rotate synchronously in the same direction. The force accumulation device indirectly drives the upper movable clamping plate 91 and the lower movable clamping plate 92 to contract simultaneously towards the center. When plates come into contact with the tablet, the upper movable clamping plate 91 and the lower movable clamping plate 92 stop contracting, while the force accumulation device is started and continues to contract inwards, thereby applying pressure to the movable clamping plate 9. A pressure sensor can also be installed in the sliding block mounting groove. The pressure sensor is connected to the main control board 19. Once the preset pressure by the main control board 19 is reached, the drive motor 7 stops and locks, thereby achieving the continuous clamping function for the tablet.

In Embodiment 2, being fixed by using the bidirectional synchronous clamping technology of the upper movable clamping plate 91 and the lower movable clamping plate 92 ensures that the tablet remains centered within the clamping device, providing a better visual effect.

The invention is provided with a power module 6, a drive motor 7, lead screws 8, threaded sliding blocks 15 and a proximity sensor 12. The movable clamping plate 9 is slidably installed on the electric chuck component 5. The power module 6 supplies power to the drive motor 7. The drive motor 7 then drives the threaded sliding block 15 through the drive of the lead screws 8. The threaded sliding blocks 15 drive the movable clamping plates 9 to move up and down relative to the electric chuck component 5, thereby clamping electronic equipment of different specifications.

The proximity sensor 12 arranged in the invention detects whether the electronic equipment 5 is placed on the electric chuck component 5. Upon detecting the electronic equipment, the main control board 19 controls the drive motor 7 to perform automated clamping operations. Button 13 and indicator light strip 14 provide intuitive operation, enhancing practical convenience during use. This design improves clamping efficiency, achieves one-handed operation, and facilitates quick and easy fixing and removal of tablets.

The invention is also equipped with the force accumulation device such as connecting spring or force accumulation spring 20. The spring accumulates force to continuously apply high pressure on electronic equipment such as tablets when tightened at different sizes. Moreover, the pressure remains balanced, ensuring that the clamping effect is consistent across different tablet sizes, thereby improving the efficiency and stability of clamping.

Finally, it should be noted that the above embodiments are merely intended to illustrate the technical proposals of the invention but do not limit its scope. Although the invention has been described in detail with reference to preferred embodiments, those of ordinary skill in the art should understand that modifications or equivalent replacements to the technical proposals of the invention can be made without departing from the spirit and scope of the invention. All such modifications and replacements shall fall within the scope of the claims of the invention.

Standard parts used in the invention can be purchased from the market, while special-shaped parts can be customized according to the descriptions in the specification and drawings. The parts are connected using conventional techniques such as bolts, rivets and welding, which are well-established in the prior art. The machines, parts and equipment are of conventional models used in prior art, and circuit connections follow standard methods known in the art. These details will not be further elaborated here.

In the description of the invention, unless otherwise explicitly specified and defined, terms such as “installed”, “connected”, “coupled” and “fixed” may refer to various connection types. For example, they may indicate fixed, detachable, or integral connections; mechanical or electrical connections; direct connections or connections via an intermediate medium; or internal connections or interactive relationships between components. Those skilled in the art may understand the specific meanings of these terms in the context of the invention, as the case may be.

1. A clamping device for near-field induction automated electronic equipment, comprising a base and an electric chuck component; the base and the electric chuck component are movably connected; a clamping mechanism is installed inside the electric chuck component and comprises a power module, a drive motor, a lead screw, a movable clamping plate, a motor bracket and a threaded sliding block; the power module is fixedly installed inside the electric chuck component; the motor bracket is fixedly arranged inside the electric chuck component; the drive motor is fixedly installed in the motor bracket, and the lead screw is installed at the output end of the drive motor; the threaded sliding block is arranged in the electric chuck component, is connected to the lead screw in a driveway, and is connected to the back of the movable clamping plate; the movable clamping plate is slidably connected to the electric chuck component; the drive motor drives the threaded sliding block to move the movable clamping plate up and down relative to the electric chuck component; a force accumulation device is also arranged between the movable clamping plate and the threaded sliding block; the movable clamping plate is used to clamp and fix the equipment to be clamped on the electric chuck component;
a proximity sensor for detecting the equipment to be clamped is also installed on the electric chuck component, a main control board is arranged inside the electric chuck component, and the power module, the drive motor, the proximity sensor and the main control board are electrically connected.

2. The clamping device for the near-field induction automated electronic equipment according to claim 1, wherein the proximity sensor is an eddy current proximity sensor, a capacitive near-field sensor or an infrared proximity sensor.

3. The clamping device for the near-field induction automated electronic equipment according to claim 1, wherein a clamping bracket is fixedly arranged at the bottom of the electric chuck component, and the equipment to be clamped is clamped and fixed between the movable clamping plate and the clamping bracket.

4. The clamping device for the near-field induction automated electronic equipment according to claim 1, wherein a button is arranged in the bottom center of the back of the electric chuck component; the electric chuck component is also provided with an indicator light strip; the button and the indicator light strip are electrically connected to the main control board.

5. The clamping device for the near-field induction automated electronic equipment according to claim 1, wherein a damping rotating shaft hinged seat is fixedly installed on the upper surface of the base; a connecting plate is movably installed on the damping rotating shaft hinged seat; the other end of the connecting plate deviating from the base is connected to the electric chuck component through a buckle component.

6. The clamping device for the near-field induction automated electronic equipment according to claim 1, wherein steel shafts are fixedly installed on both sides inside the electric chuck component; an upper fixing plate and a lower fixing plate extend horizontally on the back of the movable clamping plate; the steel shafts pass through the upper fixing plate and the lower fixing plate, allowing the movable clamping plate to slide up and down along the steel shafts; the threaded sliding block and the force accumulation device are installed between the upper fixing plate and the lower fixing plate;
the force accumulation device comprises a force accumulation spring and a movable sleeve; the threaded sliding block and the movable sleeve are sleeved on the steel shafts, and the compressed force accumulation spring is installed between the threaded sliding block and the movable sleeve; the upper end of the threaded sliding block is abutted against the upper fixing plate, and the lower end of the movable sleeve is abutted against the lower fixing plate.

7. The clamping device for the near-field induction automated electronic equipment according to claim 1, wherein the electric chuck component comprises a front housing and a rear housing; the motor bracket is fixedly installed on the rear housing; the movable clamping plate comprises an upper movable clamping plate and a lower movable clamping plate; the drive motor adopts a dual-output structure; the lead screws connected to the upper and lower output ends of the drive motor are respectively driven and connected to the threaded sliding blocks installed in the upper and lower movable clamping plates; the force accumulation device is also arranged between the threaded sliding blocks and the movable clamping plates.

8. The clamping device for the near-field induction automated electronic equipment according to claim 7, wherein the force accumulation device comprises a force accumulation spring and steel mounting shafts; the movable clamping plate is provided with a sliding block mounting groove; the lead screw passes through the sliding block mounting groove to be in threaded connection with the threaded sliding block installed in the sliding block mounting groove; the steel mounting shafts are fixedly installed on both sides of the lead screw in sliding block mounting groove; the threaded sliding block is sleeved on the steel mounting shaft and moves up and down along the steel mounting shaft; the force accumulation spring is also installed on the steel mounting shaft and is abutted against the sliding block mounting groove and the threaded sliding block.

9. The clamping device for the near-field induction automated electronic equipment according to claim 7, wherein a steel limit shaft is fixedly installed in the rear housing; the upper and lower movable clamping plates are sleeved on the steel limit shaft and move up and down along the steel limit shaft.
